(19) United States
(12) Patent Application Publication
(10) Pub. No.: US 2016/0052155 A1
(43) Pub. Date: Feb. 25, 2016

(54) CUTTING DEVICE

(71) Applicant: Larry Gee Walden, Indianapolis, IN (US)

(72) Inventor: Larry Gee Walden, Indianapolis, IN (US)

(21) Appl. No.: 14/163,083

(22) Filed: Jan. 24, 2014

Related U.S. Application Data
(60) Provisional application No. 61/756,194, filed on Jan. 24, 2013.

(51) Int. Cl. B26D 3/08; B26D 7/01

(52) U.S. Cl. CPC B26D 3/08; B26D 7/01

(57) ABSTRACT

A cutting device is disclosed that is configured and operable to assist in the removal of a wrapper from a wrapped roll of coins. The cutting device includes a housing defining a coin wrapper tray. A first, second, and third opening are located in a base of the coin wrapper tray. A first roller is positioned in the first opening, a circular cutter is positioned in the second opening, and a second roller is positioned in the third opening. A wrapped roll of coins can be positioned in the coin wrapper tray and when rotated, the circular cutter places an incision in the wrapper so that the coins can be removed from the wrapper.

### CROSS REFERENCE TO RELATED APPLICATION

The present application claims the benefit of and priority to U.S. Provisional Application No. 61/756,194 filed on Jan. 24, 2013.

### BACKGROUND

Rolled coins need to be opened in order to be used in commerce. It is difficult to open rolls of coins using just your hands. Several different devices exist that can be used to open rolls of coins, but many are complex in design. As such, a need exists for a portable cutting device that can be used to open rolls of coins of any denomination (e.g.—quarters, dimes, nickels and pennies) in a safe and efficient manner.

### BRIEF DESCRIPTION OF THE DRAWINGS

FIG. 1 is a perspective view of a cutting device.

FIG. 2 is an exploded view of the cutting device illustrated in FIG. 1.

FIG. 3 is a top view of the cutting device illustrated in FIG. 1.

FIG. 4 is a cross-sectional view of the cutting device along axis A-A in FIG. 3.

FIG. 5 is a cross-sectional view of the cutting device along axis B-B in FIG. 3.

FIG. 6 is an end view of the cutting device illustrated in FIG. 1 having a wrapped roll of coins positioned in the cutting device.

FIG. 7 is a perspective view of an alternative cutting device.

FIG. 8 is a top view of the cutting device illustrated in FIG. 7.

FIG. 9 is a cross-sectional view of the cutting device along axis A-A in FIG. 8.

FIG. 10 is a cross-sectional view of the cutting device along axis B-B in FIG. 8.

FIG. 11 is an end view of the cutting device illustrated in FIG. 7 having a wrapped roll of coins positioned in the cutting device.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

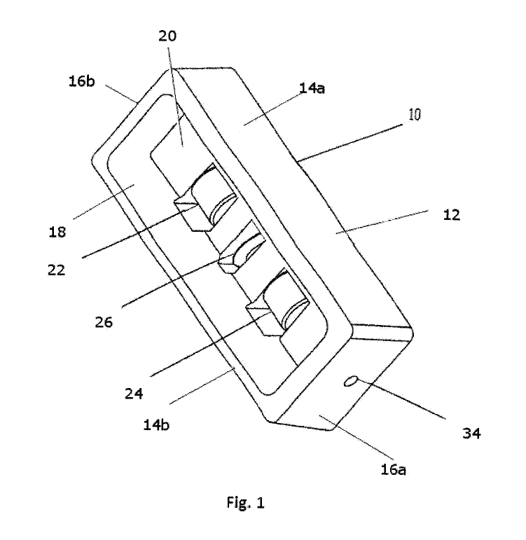

Referring to FIG. 1, a coin wrapper cutting device 10 is illustrated. The cutting device 10 includes a generally rectangular shaped housing 12 that includes a pair of opposing side walls 14a, 14b and a pair of opposing end walls 16a, 16b. The side walls 14a, 14b and end walls 16a, 16b define an interior opening or coin wrapper tray 18 that includes a base 20. In one form, the interior opening 18 is about the size of a roll of quarters or about one inch.

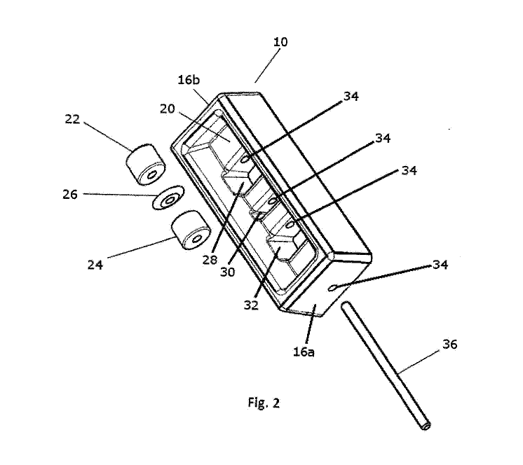

Referring to FIGS. 1 and 2, the cutting device 10 includes a first roller 22, a second roller 24, and a circular cutter 26. As illustrated, the base 20 includes a first opening or cavity 28, a second opening or cavity 30, and a third opening or cavity 32. The first opening 28 is sized and configured to receive the first roller 22. The second opening 30 is sized and configured to receive the circular cutter 26. The third opening 32 is sized and configured to receive the second roller 24. The first end wall 16a includes an aperture 34 that runs longitudinally through the entire length of the base 20 and openings 28, 30, 32 to the second end wall 16b as illustrated in FIG. 2. The aperture 34 is sized and configured to receive an axle pin 36 that is inserted to secure the first roller 22, circular cutter 26, and second roller 24 in their respective openings 28, 30, 32.

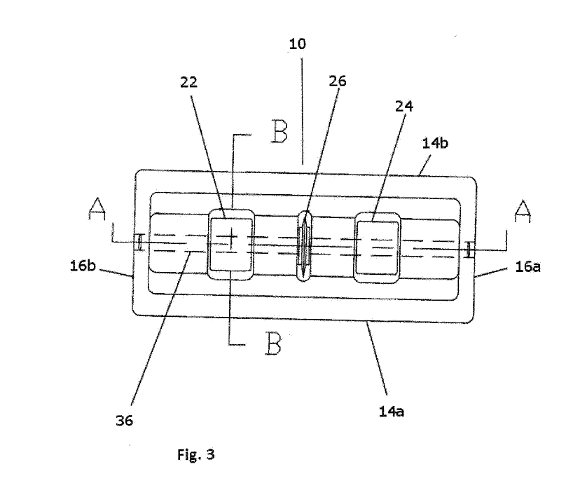

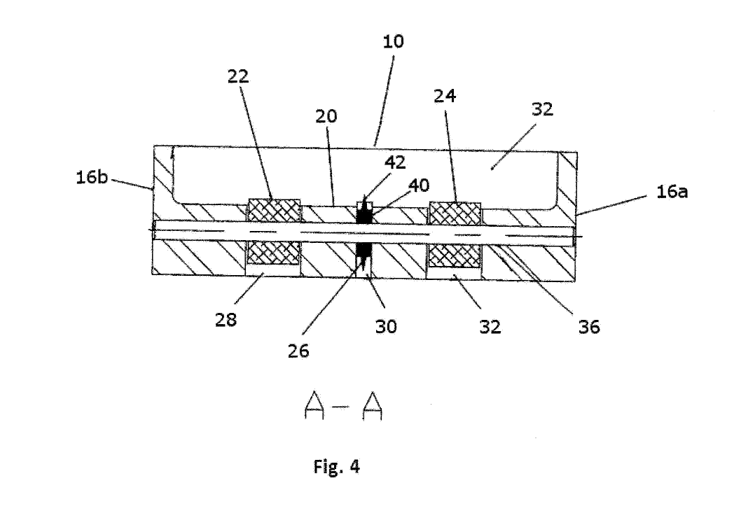

Referring to FIG. 3, a top view of the cutting device 10 is illustrated as assembled. FIG. 4 is a cross-section view of the cutting device 10 along longitudinal axis A-A in FIG. 3. As illustrated, the rollers 22, 24 are positioned in the openings 28, 32 and held in place by the axle pin 36. The rollers 22, 24 are oriented on the axle pin 36 such that they are capable of spinning on the axle pin 36 when a roll of coins is positioned within the coin wrapper tray 18. As illustrated, the rollers 22, 24 protrude upwardly slightly from the base 20 such that a lower portion of the roll of coins will rest on the rollers 22, 24. The circular cutter 26 includes a cylindrical portion 40 and a sharp cutting end 42. The axle pin 36 extends through a central portion of the cylindrical portion 40 of the circular cutter 26. An upper portion of the sharp cutting end 42 extends above the base 20 and an upper end of the rollers 22, 24. The sharp cutting end 42 extends upwardly such that a portion of the sharp cutting end 42 is able to penetrate the wrapper on a roll of coins. As such, as a roll of coins is spun in the coin wrapper tray 18, both the rollers 22, 24 and the circular cutter 26 spin and as the roll of coins is spun the sharp cutting end 42 of the circular cutter 26 cuts the wrapper of the roll of coins.

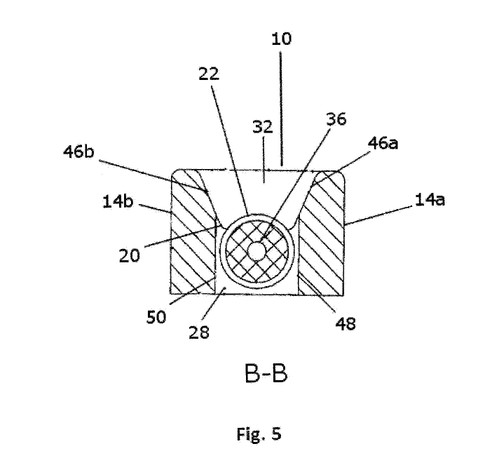

FIG. 5 is a cross-section view of the cutting device 10 along axis B-B in FIG. 3. As illustrated, in one form an inner portion 46a, 46b of the side walls 14a, 14b tapers downwardly toward the base 20. This taper facilitates rotation of a roll of coins positioned in the coin wrapper tray 18. As further illustrated, when the rollers 22, 24 are installed in their respective openings 28, 32, the diameter of the rollers 22, 24 is sized such that the rollers 22, 24 are spaced apart from interior side walls 48, 50 defined by the openings 28, 32 when positioned on the axle pin 36.

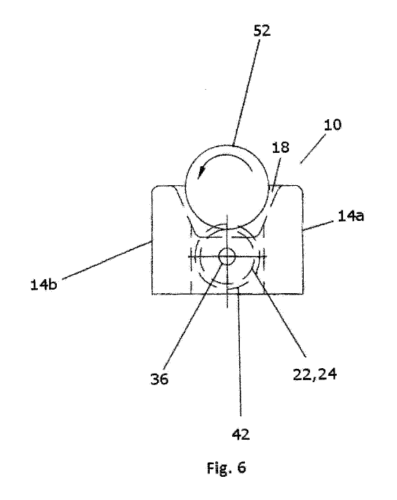

Referring to FIG. 6, an end view of the cutting device 10 is illustrated with end wall 16a shown in phantom view. A wrapped roll of coins 52 has been positioned in the coin wrapper tray 18. As illustrated, the outside diameter of the wrapped roll of coins 52 rests on the rollers 22, 24. The sharp cutting end 42 of the circular cutter 26 cuts through and penetrates the wrapper of the wrapped roll of coins 52. As the wrapped roll of coins 52 is rotated or rolled in the coin wrapper tray 18, the rollers 22, 24 rotate and the circular cutter 26 rotates thereby cutting the wrapper of the wrapped roll of coins 52.

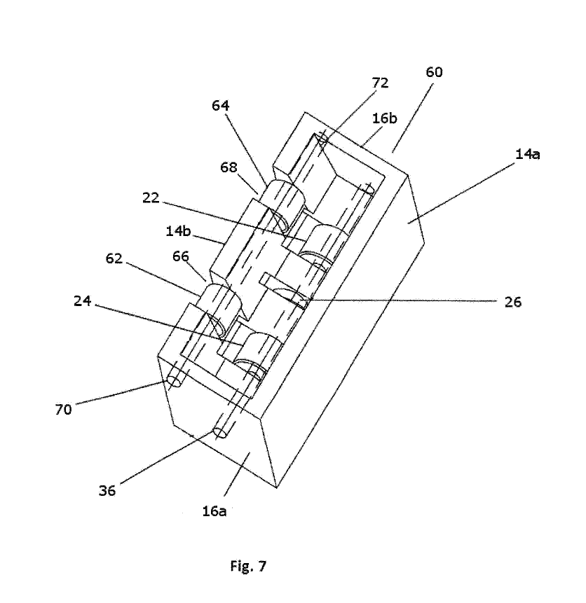

Referring to FIG. 7, an alternative cutting device 60 is illustrated. In this form, a side wall 14b of the cutting device 60 can be modified to include a third roller 62 and a fourth roller 64. As illustrated, in this representative form the rollers 62, 64 can be aligned adjacent to the first and second rollers 22, 24 positioned in the base 20 of the housing 12. The side wall 14b includes a first opening or cavity 66 and a second opening or cavity 68. A second aperture 70 extends through the side wall 14b from the first end wall 16a to the second end wall 16b. A second axle pin 72 (shown in phantom view in FIG. 7) extends through the second aperture 70 and through the third and fourth rollers 62, 64. All other features remain the same as in the first embodiment discussed above and for the sake of brevity will not be repeated.

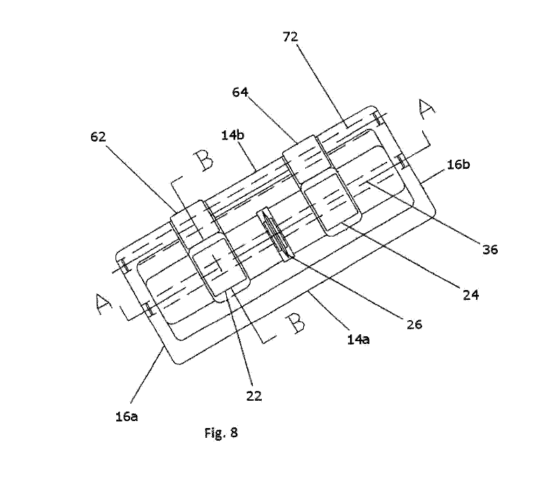

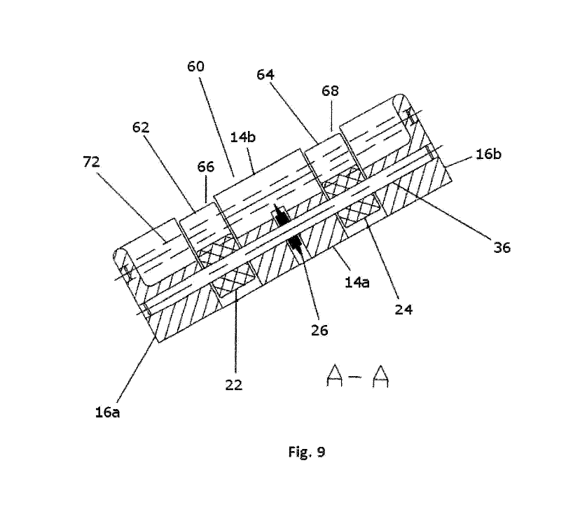

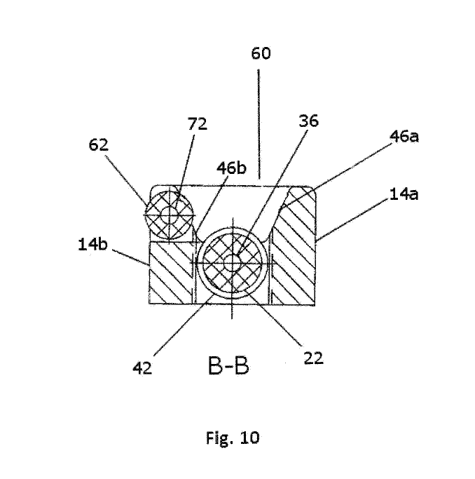

Referring to FIG. 8, a top view of the cutting device 60 is illustrated as assembled. FIG. 9 is a cross-section view of the cutting device 60 along longitudinal axis A-A in FIG. 8. As illustrated, the third and fourth rollers 62, 64 are positioned in the openings 66, 68 in the side wall 14b of the cutting device 60. The third and fourth rollers 62, 64 further facilitate rotation of the wrapped roll of coins 52. FIG. 10 is a cross-sectional view of the cutting device 60 along axis B-B in FIG. 8. As illustrated, the outside diameter of the third roller 62 is sized such that a portion of the roller 62 protrudes slightly outside the tapered inside wall 46b.

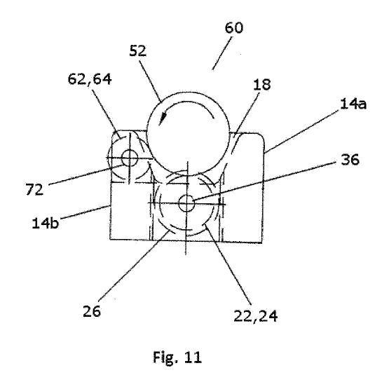

Referring to FIG. 11, an end view of the cutting device 60 is illustrated with end wall 16a shown in phantom view. A wrapped roll of coins 52 has been positioned in the coin wrapper tray 18. As illustrated, the outside diameter of the wrapped roll of coins 52 rests on the base rollers 22, 24 and side rollers 62,64. The sharp cutting end 42 of the circular cutter 26 cuts through and penetrates the wrapper of the wrapped roll of coins 52. As the wrapped roll of coins 52 is rotated or rolled in the coin wrapper tray 18, the base rollers 22, 24 and side rollers 62, 64 rotate and the circular cutter 26 rotates thereby cutting the wrapper of the wrapped roll of coins 52.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A cutting device, comprising:
a housing defining a coin wrapper tray;
a first, second, and third opening in a base of said coin wrapper tray; and
a first roller positioned in said first opening, a circular cutter positioned in said second opening, and a second roller positioned in said third opening.

2. The cutting device of claim 1, further comprising an aperture running through said base of said coin wrapper tray.

3. The cutting device of claim 2, further comprising an axle pin positioned in said aperture such that said axle pin secures said first roller in said first opening, said circular cutter in said second opening, and said second roller in said third opening.

4. The cutting device of claim 3, wherein said axle pin is sized and configured such that said first roller, said circular cutter, and said second roller are capable of rotating.

5. The cutting device of claim 1, wherein said housing includes a first side wall, a second side wall, a first end wall and a second end wall that define said coin wrapper tray.

6. The cutting device of claim 5, wherein an inner portion of said first side wall tapers inwardly downward toward said base and a second inner portion of claim second side wall tapers inwardly downward toward said base.

7. The cutting device of claim 5, wherein said first side wall includes a fourth opening and a fifth opening.

8. The cutting device of claim 7, wherein a third roller is positioned in said fourth opening and a fourth roller is positioned in said fifth opening.

9. The cutting device of claim 8, wherein said first side wall includes a second aperture, wherein a second axle pin is positioned in said second aperture thereby securing said third roller in said fourth opening and said fourth roller in said fifth opening.

10. The cutting device of claim 9, wherein an inner portion of said first side wall tapers inwardly downward toward said base and a second inner portion of claim second side wall tapers inwardly downward toward said base.

11. A cutting device, comprising:
a housing comprising a first side wall, a second side wall, a first end wall, a second end wall and a base that define an interior coin wrapper tray, wherein said base includes an aperture running from said first end wall to said second end wall;
a first opening in said base, a second opening in said base, and a third opening in said base;
a first roller positioned in said first opening, a circular cutter positioned in said second opening, and a second roller positioned in said third opening; and
an axle pin positioned in said aperture to secure said first roller in said first opening, said circular cutter in said second opening, and said second roller in said third opening.

12. The cutting device of claim 11, wherein a first interior portion of said first side wall tapers inwardly downward toward said base and a second interior portion of said second side wall tapers inwardly downward toward said base.

13. The cutting device of claim 11, wherein said first and second rollers extend slightly upward from said base.

14. The cutting device of claim 11, wherein said circular cutter comprises a generally cylindrical portion and a cutting end.

15. The cutting device of claim 14, wherein said cutting end of said circular cutter extends above a top surface of said first and second rollers.

16. The cutting device of claim 11, wherein said first side wall includes a fourth opening and a fifth opening, wherein a third roller is positioned in said fourth opening and a fourth roller is positioned in said fifth opening.

17. The cutting device of claim 16, wherein said first side wall includes a second aperture running from said first end wall to said second end wall.

18. The cutting device of claim 17, further comprising a second axle pin positioned in said second aperture thereby securing said third roller in said fourth opening and said second roller in said fifth opening.

19. A cutting device, comprising:
a housing comprising a first side wall, a second side wall, a first end wall, a second end wall and a base that define an interior coin wrapper tray, wherein said base includes a first aperture running from said first end wall to said second end wall, wherein said first side wall includes a second aperture running from said first end wall to said second end wall, wherein said first side wall includes a first interior wall that tapers inwardly downward toward said base and said second side wall includes a second interior wall that tapers inwardly downward toward said base;
a first opening in said base, a second opening in said base, and a third opening in said base;
a fourth opening in said first side wall and a second opening in said first side wall, wherein said fourth opening is generally aligned with said first opening in said base and said fifth opening is generally aligned with said third opening in said base;
a first roller positioned in said first opening in said base, a circular cutter positioned in said second opening in said base, and a second roller positioned in said third opening in said base;
a third roller positioned in said fourth opening in said first side wall and a fourth roller positioned in said fifth opening in said first side wall;
a first axle pin positioned in said first aperture to secure said first roller in said first opening, said circular cutter in said second opening, and said second roller in said third opening; and
a second axle pin positioned in said second aperture to secure said third roller in said fourth opening in said first side wall and said fourth roller in said fifth opening in said first side wall.
